(19) United States
(12) Patent Application Publication
(10) Pub. No.: US 2006/0153540 A1
(43) Pub. Date: Jul. 13, 2006

(54) Data stream reocrding method and device

(76) Inventors: Masanori Itoh, Moriguchi-shi (JP); Osamu Okauchi, Hirakata-shi (JP); Yasuyuki Kurosawa, Katano-shi (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 10/544,160

(22) PCT Filed: Feb. 2, 2004
(86) PCT No.: PCT/JP04/01010

§ 371 Date: Aug. 1, 2005

(30) Foreign Application Priority Data
Feb. 3, 2003 (JP) 2003-025591

(51) Int. Cl. H04N 7/26

(52) U.S. Cl. 386/112

(57) ABSTRACT

Each of a first data stream in a first format and a second data stream in a second format is an arrangement of a plurality of data units, each including compressed and encoded video data. In the first and second formats, first and second time ranges are respectively set to define a permissible variation in the video playback duration of the respective data units. The method includes the steps of: receiving a content representing the video; generating the compressed and encoded video data of the content; making the data units out of the video data such that the playback duration of each said data unit falls within both of the first and second time ranges; and recording the first data stream, including the data units, on the storage medium.

### TECHNICAL FIELD

The present invention relates to a method and apparatus for recording a content including video and audio in real time.

### BACKGROUND ART

Various types of data streams have been standardized to encode and compress video data at low bit rates. A system stream compliant with MPEG2 system standard ISO/IEC 13818-1 is known as one such data stream. A “system stream” is a generic term for the three types of streams, namely, program stream (PS), transport stream (TS) and PES stream.

In recent years, more and more attention has been paid to phase change optical disks, MOs and other optical disks as data stream storage media to replace magnetic tapes. The DVD Video Recording standard. (i.e., DVD Specifications for Rewritable/Re-recordable Discs Part 3 VIDEO RECORDING, version 1.0, September 1999, which will be referred to herein as “VR standard”) is currently known as a standard for recording the data stream of some content on a phase change optical disk (such as a DVD) in real time and for making it editable. Also, the DVD Video standard (which will be referred to herein as “Video standard”) is also defined as a standard for a package medium to store the data stream of a read-only content such as a movie thereon.

FIG. 1 shows a data structure for an MPEG2 program stream 10 compliant with the VR standard (which will be referred to herein as a “VR-compliant stream 10”). The VR-compliant stream 10 includes a plurality of video object units (VOBUs). Although only two VOBUs are shown in. FIG. 1, more VOBUs may be included. If the VR-compliant stream 10 includes three or more VOBUs, then the first through the last but one VOBUs are supposed to correspond to the first VOBU shown in FIG. 1, while the last VOBU is supposed to correspond to the second VOBU shown in FIG. 1.

In the VR-compliant stream 10, each VOBU is made up of a plurality of packs. Each pack has a fixed data length (also called a “pack length”) of 2 kilobytes (i.e., 2,048 bytes). At the top of the VOBU, a real time information pack (RDI pack) 11, 14 is positioned as indicated by “RDI” in FIG. 1. The RDI pack 11 is followed by multiple video packs “V” (including video packs 12, 13) and an audio pack “A”.

Each pack stores the following information. As disclosed in Japanese Patent Application Laid-Open Publication No. 2001-197417, for example, the RDI pack 11 stores various information for controlling the playback of the VR-compliant stream 10, e.g., aspect information, information representing the decoding timing of the RDI_PCK and information for controlling copying of the VR-compliant stream 10. The decoding timing is shown by the same data structure as the presentation time stamp (PTS). The audio packs store audio data that was compressed so as to comply with the MPEG2 Audio standard, for example. The video packs 12 store MPEG2-compressed video data 12a thereon. The video pack 12 further includes a pack header 12b and a PES packet header 12c indicating the identity as a video pack. Also, if the video pack 12 is the first one of the VOBU, a system header (not shown) is further included in the pack header 12b.

The video data 12a of the video pack 12 shown in FIG. 1, along with the video data 13a and so on of the following video packs 13, etc., make up the data of an I-frame 15. After the I-frame, video packs making up a B-frame or a P-frame are recorded continuously.

The video data 12a further includes a sequence header 17 and a GOP header 18. The MPEG2 standard defines a “group of pictures (GOP)” as a group of video frames. The GOP header 18 indicates the top of each GOP. The first frame of each GOP is always an I-frame.

In the VR-compliant stream 10, each VOBU is made up of at least one GOP. The overall playback duration of all GOPs within a single VOBU is adjusted so as to fall within the range of 0.4 second to 1.0 second in principle. The last VOBU is an exception, in which the overall playback duration is adjusted so as to fall within the range of 0 seconds to 1.0 second. This is because the VR-compliant stream 10 is recordable in real time and can stop being recorded in a time of less than 0.4 second. As long as the overall playback duration falls within any of these ranges, the variation in video playback duration is allowed for any VOBU.

FIG. 2 shows a data structure for an MPEG2 program stream 10 compliant with the Video standard (which will be referred to herein as a “Video-compliant stream 20”). The data structure of the Video-compliant stream 20 is similar to that of the VR-compliant stream 10. That is to say, the Video-compliant stream 20 also includes a plurality of VOBUs, and each VOBU is made up of a plurality of packs. Each pack has a fixed data length (also called a “pack length”) of 2 kilobytes (i.e., 2,048 bytes).

At the top of each VOBU, a navigation pack 21, 23 is positioned as indicated by “NV” and as disclosed in Japanese Patent Application Laid-Open Publication No. 10-31876, for example. In the navigation pack, information for controlling the video data and audio data is stored. Also, the navigation pack is followed by video packs 22 in which video data are stored and audio packs in which audio data are stored.

As in the VR-compliant stream 10, each VOBU of the Video-compliant stream 20 is also made up of at least one GOP. Accordingly, the video packs of the Video-compliant stream 20 have almost the same data structure as the video packs 12, 13 shown in FIG. 1.

In the Video-compliant stream 20, the overall playback duration of all GOPs included in a single VOBU is adjusted so as to fall within the range of 0.4 second to 1.0 second in principle. The last VOBU is an exception, in which the overall playback duration is adjusted so as to fall within the range of 0.4 second to 1.2 seconds. As long as the overall playback duration falls within any of these ranges, the variation in video playback duration is allowed for any VOBU.

In converting the VR-compliant stream 10 into the Video-compliant stream 20, not only conversion of the RDI packs into navigation packs but also adjustment of the playback duration of the last VOBU, located at the end of the stream, are needed. For example, if the last VOBU of the VR-compliant stream 10 has a playback duration of less than 0.4 second, then the playback duration of the last VOBU needs to be adjusted in the resultant Video-compliant stream 20 so as to fall within the range of 0.4 second through 1.2 seconds.

In this case, to adjust the playback duration of the last VOBU, video data sometimes needs to be decoded and compressed and encoded (i.e., recompressed). Hereinafter, a situation requiring such recompression processing will be described with reference to FIG. 3.

FIG. 3 shows exemplary conventional conversion processing for converting a VR-compliant stream 10 into a Video-compliant stream 20. In FIG. 3, only the last two VOBUs (namely, VOBU(k−1) and VOBU(k)) of the VR-compliant stream 10 and the Video-compliant stream 20 are shown. Also, a video of 1 second is supposed to be played back in 30 frames as in the NTSC standard. VOBU(k−1) of the VR-compliant stream 10 includes GOP(n−2) consisting of 12 frames and GOP(n−1) consisting of 18 frames and has a combined playback duration of 1.0 second. On the other hand, VOBU(k) includes GOP(n) consisting of 9 frames and has a playback duration of 0.3 second.

In the prior art, the last three frames (i.e., P-, B- and B-frames) of GOP(n−1) are changed into frames of GOP(n). This is because the total playback duration of these three frames is 0.1 second. Thus, adding this playback duration to that of GOP(n) of 0.3 second, the combined playback duration will be 0.4 second, which complies with the Video standard.

In this case, the top of GOP(n) must be an I-frame. Accordingly, the B-frame needs to be decoded once and then compressed and encoded as an I-frame again. As a result, in a bidirectional coding process for generating the B-frame, the data of the reference frame (i.e., the I-frame in the example illustrated in FIG. 3) must be changed, and therefore, not only the top frame but also a number of frames that follow it need to be recompressed.

Furthermore, it is also possible to form a single VR-compliant stream by connecting together a number of VR-compliant streams (or VOBs to be described later), each of which is a single continuous stream on its own. FIG. 12 shows the data structure of a VR-compliant stream formed by connecting together a number of continuous VR-compliant streams (i.e., VOBs #1, #2, . . . and #k). In this connecting process, each of those continuous VR-compliant streams needs to satisfy the VOBU playback duration requirement shown in FIG. 1. That is to say, the VOBU located just before each connection point and the last VOBU need to have a playback duration of 1.0 second or less. Meanwhile, a connected Video-compliant stream has a similar data structure to that of the original VR-compliant streams. FIG. 13 shows the data structure of a Video-compliant stream formed by connecting together a number of continuous Video-compliant streams (i.e., VOBs #1, #2, . . . and #k). In this Video-compliant stream, the VOBU located just before each connection point and the last VOBU need to have a playback duration of 0.4 second through 1.2 seconds. Accordingly, if the connected VR-compliant streams are converted into a Video-compliant stream without deleting any particular frame, the recompression processing should be carried out at each connection point under the worst conversion conditions.

As used herein, the “continuous stream” refers to a program stream that satisfies the continuity conditions defined by the MPEG-2 System standard. More specifically, the “continuous stream” refers to a stream being input to a system target decoder (P-STD) temporally continuously. This means that the PTS, DTS and SCR values are assigned by reference to a continuous system time clock. This also means that no data underflows in each buffer of the system target decoder. The details are defined by the MPEG-2 System standard.

As described above, according to the conventional technique, complicated and high-load processing must be carried out to convert a VR-compliant stream into a Video-compliant stream without deleting any particular frame, which takes a lot of time to get the conversion done.

Thus, an object of the present invention is to generate a VR-compliant stream that need not be recompressed when converted into a Video-compliant stream.

### DISCLOSURE OF INVENTION

A recording method according to the present invention is a method for selectively recording a first data stream in a first format, not a second data stream in a second format, on a storage medium. Each data stream is an arrangement of a plurality of data units, each including compressed and encoded video data. In the first format, a first time range is set to define a permissible variation in the video playback duration of the respective data units. In the second format, a second time range is set to define a permissible variation in the video playback duration of the respective data units. The method includes the steps of: receiving a content representing the video; generating the compressed and encoded video data of the content; making the data units out of the video data such that the playback duration of each said data unit falls within both of the first and second time ranges; and recording the first data stream, including the data units, on the storage medium.

The first time range may include a time range for a first terminal data unit, which is located at the end of the first data stream, and a time range for the data units other than the first terminal data unit. The second time range may include a time range for a second terminal data unit, which is located at the end of the second data stream, and a time range for the data units other than the second terminal data unit. The step of making the data units may include making the terminal data units such that the playback duration of each said terminal data unit falls within the respective time ranges of both the first and second terminal data units.

If the playback duration of a data unit being made when the first data stream finishes being recorded is less than the minimum value of the playback duration of the terminal data unit that falls within both of the two time ranges, the step of making the data units may include combining the data unit being made with its previous data unit, thereby making the terminal data unit, of which the playback duration is the minimum value of the two time ranges.

The recording method may further include the step of generating management information about the amount of data and the number of pictures included in each said data unit. The step of recording may include recording the management information on the storage medium as a different data stream from the first data stream.

The time range for the first terminal data unit may be 0 second through 1 second, and the time range for the second terminal data unit may be 0.4 second through 1.2 seconds.

The time range for the data units other than the first terminal data unit and the time range for the data units other than the second terminal data unit may be both 0.4 second through 1.0 second.

The first time range may be 0 second through 1 second, and the second time range may be 0.4 second through 1.2 seconds.

If the playback duration of a data unit being made when the first data stream finishes being recorded is less than the minimum value of the playback duration that falls within both of the two time ranges, then the step of making the data units may include discarding the data unit being made.

The step of making the data units may include receiving an instruction to stop recording the first data stream, and if the playback duration of a data unit being made when the instruction is received is less than the minimum value of the playback duration that falls within both of the two time ranges, continuing recording until the playback duration reaches the minimum value.

A recorder according to the present invention is an apparatus for selectively recording a first data stream in a first format, not a second data stream in a second format, on a storage medium. Each data stream is an arrangement of a plurality of data units, each including compressed and encoded video data. In the first format, a first time range is set to define a permissible variation in the video playback duration of the respective data units. In the second format, a second time range is set to define a permissible variation in the video playback duration of the respective data units. The recorder includes: an input section for receiving a content representing the video; a compressing section for generating the compressed and encoded video data of the content; a stream assembling section for making the data units out of the video data such that the playback duration of each said data unit falls within both of the first and second time ranges; and a writing section for recording the first data stream, including the data units, on the storage medium.

The first time range may include a time range for a first terminal data unit, which is located at the end of the first data stream, and a time range for the data units other than the first terminal data unit. The second time range may include a time range for a second terminal data unit, which is located at the end of the second data stream, and a time range for the data units other than the second terminal data unit. The stream assembling section may make the terminal data units such that the playback duration of each said terminal data unit falls within the respective time ranges of both the first and second terminal data units.

If the playback duration of a data unit being made when the first data stream finishes being recorded is less than the minimum value of the playback duration of the terminal data unit that falls within both of the two time ranges, the stream assembling section may combine the data unit being made with its previous data unit, thereby making the terminal data unit, of which the playback duration is the minimum value of the two time ranges.

The recorder may further include a control section for generating management information about the amount of data and the number of pictures included in each said data unit. The writing section may record the management information on the storage medium as a different data stream from the first data stream.

The time range for the first terminal data unit may be 0 second through 1 second, and the time range for the second terminal data unit may be 0.4 second through 1.2 seconds.

The time range for the data units other than the first terminal data unit and the time range for the data units other than the second terminal data unit may be both 0.4 second through 1.0 second.

The first time range may be 0 second through 1 second, and the second time range may be 0.4 second through 1.2 seconds.

If the playback duration of a data unit being made when the first data stream finishes being recorded is less than the minimum value of the playback duration that falls within both of the two time ranges, then the stream assembling section may discard the data unit being made.

The stream assembling section may receive an instruction to stop recording the first data stream, and if the playback duration of a data unit being made when the instruction is received is less than the minimum value of the playback duration that falls within both of the two time ranges, the stream assembling section may continue recording until the playback duration reaches the minimum value.

A first data stream, which is an MPEG-2 program stream consisting of VOBUs, each having a duration of 0.4 second through 1.0 second, as respective data units, may be recorded on the storage medium.

A data stream recording program according to the present invention, which is executable by a computer, is used to selectively record a first data stream in a first format, not a second data stream in a second format, on a storage medium. Each data stream is an arrangement of a plurality of data units, each including compressed and encoded video data. In the first format, a first time range is set to define a permissible variation in the video playback duration of the respective data units. In the second format, a second time range is set to define a permissible variation in the video playback duration of the respective data units. A recording process to be executed by the computer following the program includes the steps of: receiving a content representing the video; generating the compressed and encoded video data of the content; making the data units out of the video data such that the playback duration of each said data unit falls within both of the first and second time ranges; and recording the first data stream, including the data units, on the storage medium.

### BRIEF DESCRIPTION OF DRAWINGS

FIG. 1 shows the data structure of an MPEG-2 program stream 10 compliant with the VR standard.

FIG. 2 shows the data structure of an MPEG-2 program stream 20 compliant with the Video standard.

FIG. 3 shows exemplary conventional conversion processing for converting a VR-compliant stream 10 into a Video-compliant stream 20.

FIG. 4(a) shows the data structure of an MPEG-2 program stream 40a according to this preferred embodiment, which is compliant with the VR standard.

FIG. 4(b) shows the data structure of an MPEG-2 program stream 40b according to this preferred embodiment, which is compliant with the Video standard.

FIG. 5(a) shows a VR-compliant stream 50, of which the recording processing has been stopped while VOBU(n+1) is being recorded.

FIG. 5(b) shows a VR-compliant stream 40a according to this preferred embodiment, obtained by the conversion.

FIG. 6 shows the arrangement of functional blocks in a data processor 60 according to this preferred embodiment.

FIG. 7 is a flowchart showing how the writing control section 161 performs GOP generating processing.

FIG. 8 shows a relationship between the VR-compliant stream 40a and the storage area of the optical disk 131.

FIG. 9 shows how the VR-compliant stream 40a and management information recorded are managed by the file system of the optical disk 131.

FIG. 10 shows the data structure of a dummy video pack including a padding packet.

FIG. 11 shows a correlation between the RDI pack and the navigation pack.

FIG. 12 shows the data structure of a VR-compliant stream formed by connecting together a number of continuous VR-compliant streams (VOBs).

FIG. 13 shows the data structure of a Video-compliant stream formed by connecting together a number of continuous Video-compliant streams.

### BEST MODE FOR CARRYING OUT THE INVENTION

As used herein, the “content” refers to a piece of information including video and/or audio. That is to say, the “content” includes video information representing video and/or audio information representing audio. The content may be moving pictures taken with a camcorder or an analog broadcast, for example.

Also, the “playback duration” refers to the playback duration of the video included in a content. In the following description, a video signal compliant with the NTSC 525/60 TV System is supposed to be compressed and encoded. In this video signal, 30 video frames (more exactly, 30,000/1,001 frames) make a playback duration of 1 second and one frame is made up of two fields. Also, the term “picture” is used as a generic term that may stand for both a frame and a field.

In this preferred embodiment, an example in which a data stream in a format compliant with the DVD Video Recording standard (the VR standard) is converted into a data stream in a format compliant with the DVD Video standard (the Video standard) will be described.

Hereinafter, the data structures of two data streams, compliant with the VR standard and the Video standard, respectively, and obtained by the recording and conversion processing of this preferred embodiment, will be described first, and then various preferred embodiments of the format conversion processing will be described.

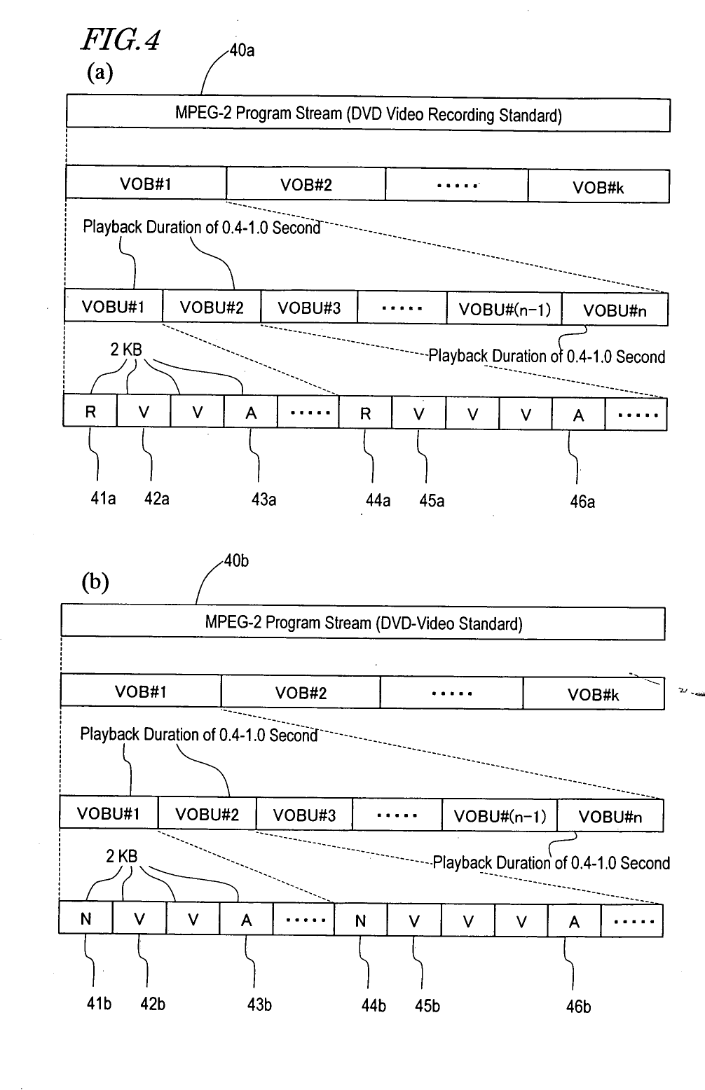

FIG. 4(a) shows a data structure for an MPEG2 program stream 40a according to this preferred embodiment, which is compliant with the VR standard (which will be referred to herein as a “VR-compliant stream 40a”).

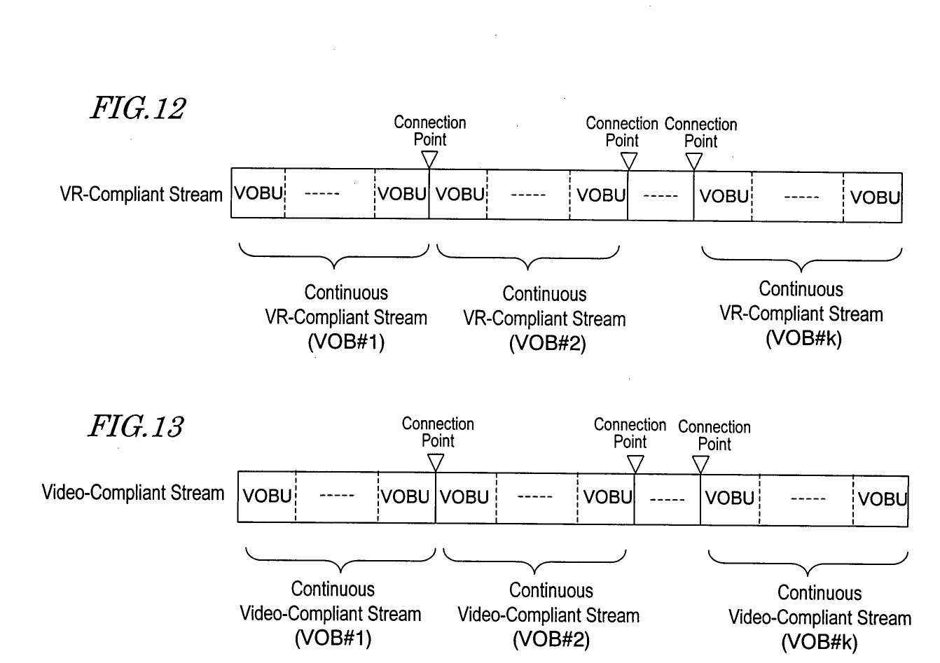

The VR-compliant stream 40a includes a plurality of video objects (VOBs) #1, #2, . . . , and #k. Supposing the VR-compliant stream 40a is a content that was taken with a camcorder, for example, each VOB stores moving picture data that was generated during a single video recording session (i.e., since the user started recording the video and until he or she stopped doing it). Also, each VOB shown in FIG. 4(a) corresponds to a single continuous VR-compliant stream, which may be implemented as the VR-compliant stream shown in FIG. 12.

Each VOB includes a plurality of VOB units (video object units; VOBUs) #1, #2, . . . , and #n. Each VOBU in a single VOB is a data unit containing video data in an amount corresponding to a playback duration of about 0.4 second to about 1 second. That is to say, the playback duration of the last VOBU also falls within the range of 0.4 second to about 1 second. In the VR-compliant stream, every VOBU but the last one may have a playback duration of 0.4 second to 1 second and the last VOBU #n may have a playback duration of 0 second to 1.0 second. Thus, the VR-compliant stream 40a satisfies both of these requirements.

Hereinafter, the data structure of VOBUs will be described with the first and second VOBUs of FIG. 4(a) taken as an example.

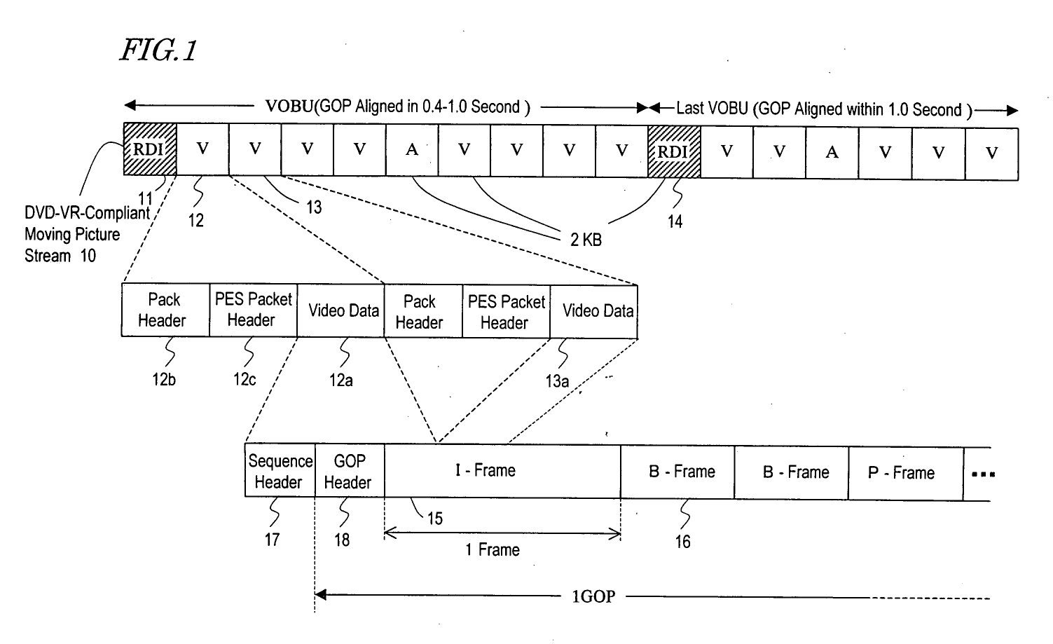

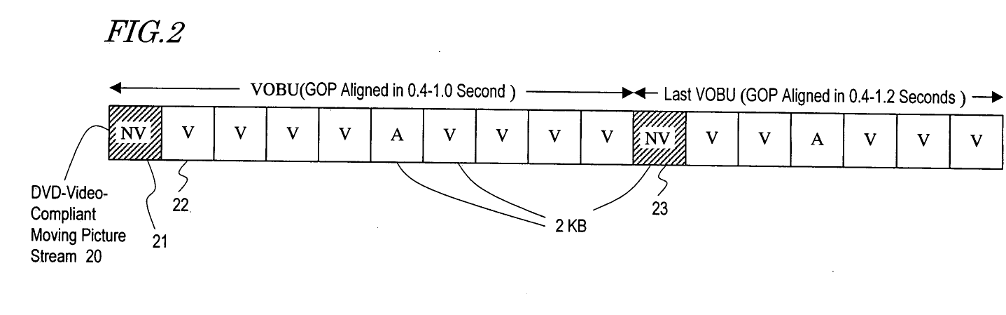

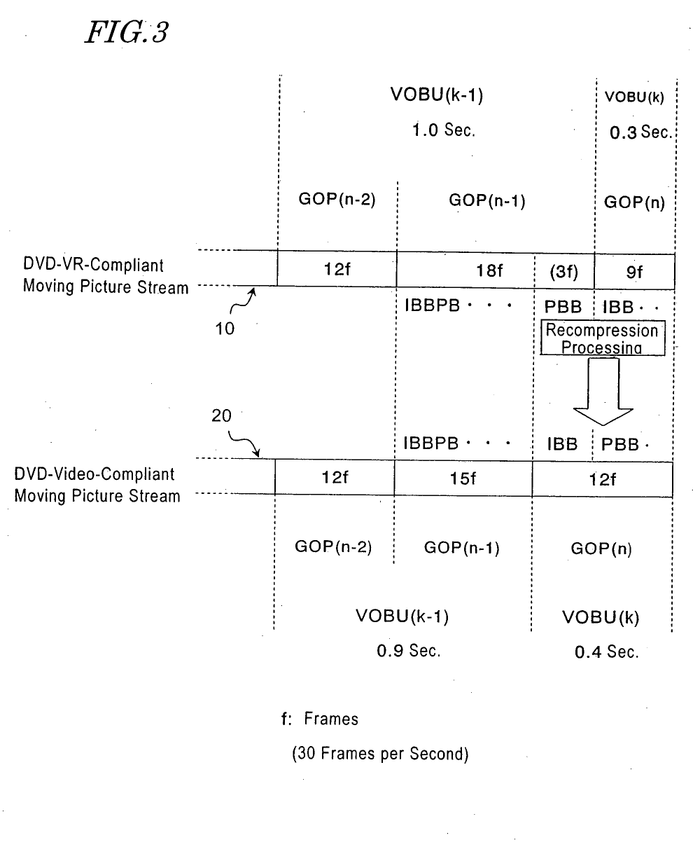

VOBU #1 is composed of a number of packs. In the VR-compliant stream 40a, each pack has a fixed data length (also called a “pack length”) of 2 kilobytes (i.e., 2,048 bytes). At the top of the VOBU, a real time information pack (RDI pack) 41a is positioned as indicated by “R” in FIG. 1(a). The RDI pack 41a is followed by multiple video packs “V” (including a video pack 42a) and multiple audio packs “A” (including an audio pack 43a). If the video data has a variable bit rate, the data size of each VOBU is changeable within a range defined by a maximum read/write rate, although the playback duration is the same. However, if the video data has a fixed bit rate, the data size of each VOBU is substantially constant.

Each pack stores the following information. Specifically, the RDI pack 41a stores various information for controlling the playback of the VR-compliant stream 40a, e.g., information representing the playback timing of the VOBU and information for controlling copying of the VR-compliant stream 40a. The video packs 42a store MPEG2-compressed video data thereon. The audio packs 43a store audio data that was compressed so as to comply with the MPEG2 Audio standard, for example. In adjacent video and audio packs 42a and 43a, video and audio data to be played back synchronously with each other may be stored. Their arrangement (order) is determined in accordance with a system target decoder model uniquely defined from the VR-compliant stream (i.e., a decoder model corresponding to P-STD described in the MPEG-2 System standard). That is to say, a buffer of a predetermined data size as defined by the decoder model is arranged so as not to overflow or underflow.

The data structure of each of those video packs is as shown in FIG. 1. The video data in each video pack includes a portion of the data of its associated video frame. A “group of pictures (GOP)” is made up of a predetermined number of frames, which begins with an I-frame. This is also just as already described with reference to FIG. 1 and the description thereof will be omitted herein.

VOBU #2 is also made up of a plurality of packs. An RDI pack 44a is located at the top of VOBU #2, and then followed by a plurality of video packs 45a and a plurality of audio packs 46a. The contents of the information to be stored in these packs are similar to those of VOBU #1.

FIG. 4(b) shows a data structure for an MPEG2 program stream 40b according to this preferred embodiment, which is compliant with the Video standard (which will be referred to herein as a “Video-compliant stream 40b ”).

The data structure of the Video-compliant stream 40b is similar to that of the VR-compliant stream 40a. Specifically, the Video-compliant stream 40b also includes a plurality of VOBs #1, #2, . . . , and #k, each of which consists of a plurality of VOBUs. And each VOBU includes video packs 42b, 45b, etc. and audio packs 43b, 46b, etc. The video packs store video data thereon and the audio packs store audio data thereon. Also, each VOB shown in FIG. 4(b) corresponds to a single continuous Video-compliant stream, which may be implemented as the VR-compliant stream shown in FIG. 12.

Each VOBU in the Video-compliant stream 40b is a data unit containing video data in an amount corresponding to a playback duration of 0.4 second to 1 second. In the Video-compliant stream 40b, every VOBU but the last one may have a playback duration of 0.4 second to 1 second and the last VOBU #n may have a playback duration of 0.4 second to 1.2 second. Thus, the Video-compliant stream 40b satisfies both of these requirements.

The differences in data structure between the Video-compliant stream 40b and the VR-compliant stream 40a are as follows. Specifically, in the Video-compliant stream 40b, not the RDI pack of the VR-compliant stream 40a but a navigation pack 41b, 44b, etc. as identified by “N” is located at the top of each VOBU. The navigation pack stores information for controlling the playback of the video data and audio data.

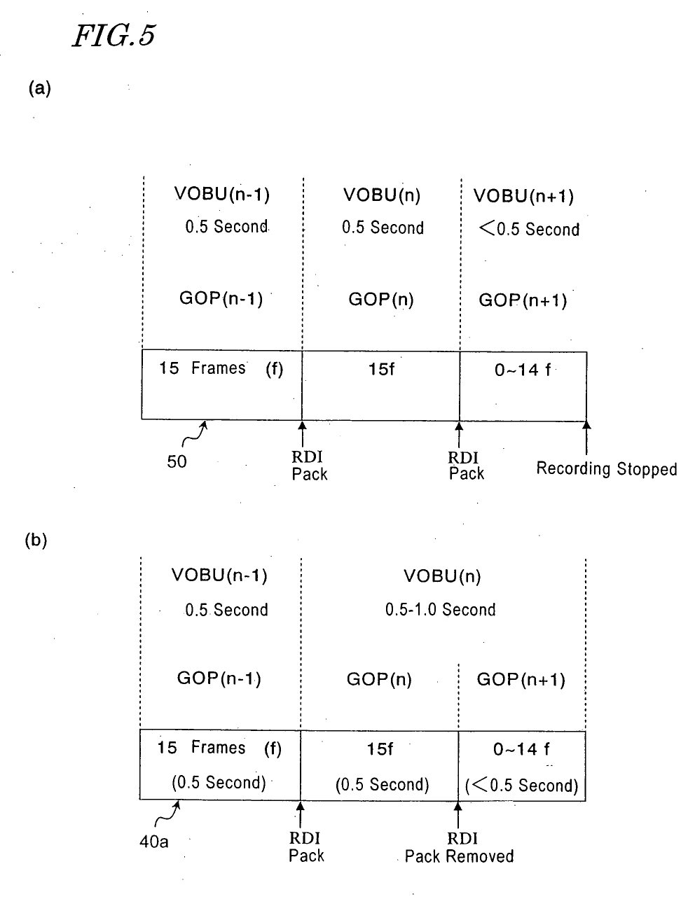

Next, the processing of recording a VR-compliant stream 50 according to this preferred embodiment will be described with reference to FIGS. 5(a) and 5(b). As will be described later, the VR-compliant stream 50 may be recorded on a phase change optical disk, for example.

FIG. 5(a) shows a VR-compliant stream 50, of which the recording processing has been stopped while VOBU(n+1) is being recorded. The VOBUs preceding VOBU(n+1) (i.e., VOBU(n−1) and VOBU(n) in the example illustrated in FIG. 5(a)) have already been recorded.

The VR standard imposes the following conditions on VOBUs. Specifically, the last VOBU should have a playback duration of 0 second through 1.0 second and all the other VOBUs should have a playback duration of 0.4 second through 1 second. One VOBU includes a number N (where N is a natural number) of GOPs. And each GOP includes video data in at most 18 frames (corresponding to 0.6 second).

In the VR-compliant stream 50 of this preferred embodiment, VOBUs are generated so as to satisfy not only the conditions mentioned above but also other conditions as well. Specifically, every VOBU but the last one should have a playback duration of 0.5 second and each VOBU should include one GOP. As a result, the number of frames included in a single GOP becomes 15. VOBU(n−1) and VOBU(n), satisfying these conditions, are shown in FIG. 5(a).

If VOBUs are generated on these conditions, then the last VOBU, at which the recording processing has been stopped, also includes one GOP, which contains video data of 0 through 14 frames. Thus, the last VOBU has a playback duration of less than 0.5 second. VOBU(n+1) satisfying these conditions is shown in FIG. 5(a).

As described above, each of the VOBUs of a VR-compliant stream includes multiple types of packs, of which the top one is always an RDI pack. Accordingly, the RDI pack is provided for not only the top of VOBU(n) that has already been recorded but also the top of VOBU(n+1), of which the recording has been stopped.

In this preferred embodiment, if the recording processing has been either stopped or finished, the processing of converting the VR-compliant stream 50 into a VR-compliant stream 40a is carried out. FIG. 5(b) shows the VR-compliant stream 40a of this preferred embodiment, obtained by the conversion. The difference between the VR-compliant stream 50 yet to be converted and the VR-compliant stream 40a converted lies in the structure of the last VOBU.

More specifically, GOP(n+1), which was stored as VOBU(n+1) in the VR-compliant stream 50 yet to be converted, is introduced as the second GOP into VOBU(n). In other words, VOBU(n) now includes two GOPs—GOP(n) and GOP(n+1). In this preferred embodiment, each VOBU is supposed to include one or more GOPs. Thus, according to this processing, VOBU(n+1) can be combined with VOBU(n). Now that VOBU(n+1) and VOBU(n) have been integrated together, VOBU(n) becomes the last VOBU in the VR-compliant stream 40a converted.

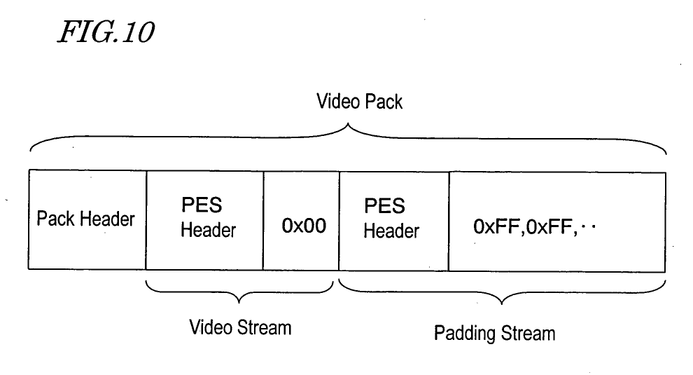

It should be noted that in the processing in which VOBU(n+1) is deleted from the VR-compliant stream 50, the RDI pack located at the top of VOBU(n+1) is switched into a video pack. This may be done by replacing the RDI pack with a dummy video pack including a padding packet as shown in FIG. 10. Meanwhile, there is no need to change the RDI pack provided at the top of VOBU(n). Optionally, the RDI pack of VOBU(n+1) may be deleted and the storage locations of the following packs may be shifted forward by one.

Even if the conversion is done as shown in FIG. 5(b), all of the conditions imposed on the VR-compliant data stream are still satisfied. Specifically, each of VOBU(n) and VOBU(n+1) in the VR-compliant stream 50 yet to be converted has a playback duration of 0.5 second or less (i.e., 15 frames or less). Thus, in the VR-compliant stream 40a converted, the last VOBU(n) has a playback duration of 0.5 second to less than 1.0 second (i.e., from 15 frames to less than 30 frames).

Furthermore, in the VR-compliant stream 40a obtained by this processing, even if no video is subjected to the recompression processing while the VR-compliant stream 40a is being converted into a Video-compliant stream 40b, all video frames can still be converted. This is because the last VOBU(n) of the VR-compliant stream 40a has a playback duration of 0.5 second to less than 1.0 second, thus satisfying the condition on the playback duration of the last VOBU of the Video-compliant stream 40b (i.e., that the VOBU should have a time range of 0.4 second through 1.2 seconds). In this manner, by imposing the conditions of this preferred embodiment while the VR-compliant stream is being generated and by integrating the last two VOBUs together after the recording processing is finished, a VR-compliant stream 40a, which can be readily converted into a Video-compliant stream 40b no matter when the VOBU recording is stopped, can be obtained. That is to say, according to the present invention, VOBUs for the VR-compliant stream 40a are generated so as to have a playback duration of 0.4 second through 1.0 second, which satisfies both the requirement on the VOBU playback duration (with a time range of 0 seconds through 1.0 second) of the VR-compliant stream 40a and that on the VOBU playback duration (with a time range of 0.4 second through 1.2 seconds) of the Video-compliant stream 40b.

In the example described above, each VOBU is supposed to have a playback duration of 0.5 second and therefore VOBU(n+1), having a playback duration of less than 0.5 second, is supposed to be combined with its previous VOBU. However, in converting the VR-compliant stream 40a into a Video-compliant stream 40b, the playback duration of each VOBU just needs to be greater than the minimum VOBU playback duration (of 0.4 second) of the Video-compliant stream 40b. For that reason, if VOBU(n+1) has a playback duration of 0.4 second to less than 0.5 second, then VOBU(n+1) does not have to be combined with the previous VOBU(n).

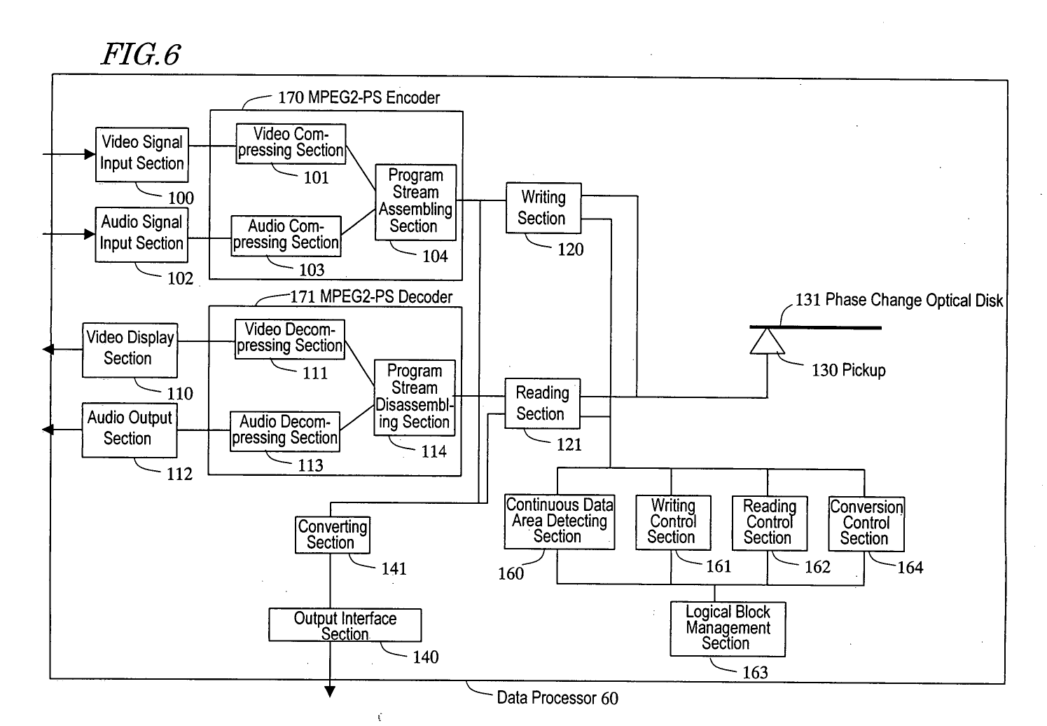

Hereinafter, a configuration for a data processor performing the processing described above will be described with reference to FIG. 6. FIG. 6 shows an arrangement of functional blocks for a data processor 60 according to this preferred embodiment. The data processor 60 writes a VR-compliant stream 50 (see FIG. 5(a)) in real time on a DVD-RAM disk, a Blu-ray disk (BD) or any other phase change optical disk 131 and then converts the VR-compliant stream 50 into the VR-compliant stream 40a (see FIG. 5(b)) on finishing writing. The VR-compliant stream 40a is finally stored on the phase change optical disk 131.

In this preferred embodiment, the VR-compliant stream 50 is supposed to be once stored on the phase change optical disk 131. Alternatively, VOBU (n+1) shown in FIG. 5(a) may be temporarily stored on the internal memory of the data processor 60, converted into the VR-compliant stream 4a and then stored on the phase change optical disk 131.

The data processor 60 may also read the VR-compliant stream from the phase change optical disk 131, convert it into a Video-compliant stream 40b and then output the stream. Furthermore, the data processor 60 also has the playback function of reading, decoding and playing the VR-compliant stream 40a. In any case, the VR-compliant stream 40a needs to be read and acquired. Thus, this function will be regarded as the playback function of the data processor 60.

It should be noted that the data processor 60 does not always have to have both of the recording and playback functions.

Hereinafter, the configuration of the data processor 60 to carry out the recording function will be described. The data processor 60 includes a video signal input section 100, an audio signal input section 102, an MPEG2-PS encoder 170, a writing section 120, a continuous data area detecting section 160, a writing control section 161 and a logical block management section 163.

The video signal input section 100 is a video signal input terminal to receive a video signal representing the video data. The audio signal input section 102 is an audio signal input terminal to receive an audio signal representing the audio data. If the data processor 60 is implemented as a videocassette recorder, for example, then the video signal and audio signal input sections 100 and 102 are respectively connected to the video output section and audio output section of a tuner section (not shown) to receive a video signal and an audio signal from the tuner section. On the other hand, if the data processor 60 is implemented as a movie recorder or a camcorder, then the video signal and audio signal input sections 100 and 102 respectively receive a video signal and an audio signal from the CCD (not shown) and microphone of the camera.

The MPEG2-PS encoder 170 (which will be simply referred to herein as an “encoder 170”) receives the video signal and audio signal, thereby generating an MPEG2 program stream (PS) compliant with the VR standard (i.e., the VR-compliant stream 50). The encoder 170 includes a video compressing section 101, an audio compressing section 103, and a PS assembling section 104. The video and audio compressing sections 101 and 103 compress and encode the video signal and audio signal, respectively, so as to comply with the MPEG2 standard, thereby generating video data and audio data. The PS assembling section 104 divides the video and audio data into video packs and audio packs, each composed of 2 kilobytes, rearranges these packs such that one VOBU is made up of these packs, and adds an RDI pack 27 to the top, thereby generating the VR-compliant stream 50. Each VOBU includes a single GOP consisting of 15 frames and corresponding to a playback duration of 0.5 second.

Under the instruction of the writing control section 161, the writing section 120 controls a pickup 130 and starts writing the video object units (VOBUs) of the VR-compliant stream 50 at the logical block address specified by the writing control section 161. In this case, the writing section 120 divides each VOBU on a 32 KB basis, adds an error correcting code to each unit, and writes it as a single logical block on an optical disk 131. If a VOBU is completely written in the middle of one logical block, then the next VOBU starts being written continuously with no gap left. The VR-compliant stream 50 may be stored on the optical disk 131 in the format shown in FIG. 5(a), for example.

Furthermore, when the processing of recording a VR-compliant stream 50 is finished, the writing section 120 changes the VR-compliant stream 50 into a VR-compliant stream 40a in accordance with the instruction given by the writing control section 161. The VR-compliant stream 40a is finally stored on the optical disk 131. In addition, the writing section 120 also records a management information file, received from the writing control section 161, on the optical disk 131.

The continuous data area detecting section 160 checks the availability of sectors on the optical disk 131, which is managed by the logical block management section 163, thereby detecting an unused continuous logical block area available.

The writing control section 161 controls the operation of the writing section 120. More specifically, the writing control section 161 instructs the continuous data area detecting section 160 in advance to detect a continuous logical block area available. Thereafter, every time writing is done on a logical block basis, the writing control section 161 notifies the writing section 120 of the logical block number in question. When the logical block has become no longer available, the writing control section 161 notifies the logical block management section 163 of the fact. It should be noted that the writing control section 161 may have the continuous data area detecting section 160 detect the size of the continuous available logical block area dynamically. The continuous data area detecting section 160 detects again the next continuous data area when the remainder of the single continuous data area becomes less than 3 seconds, for example, if converted at the maximum read/write rate. And when the single continuous data area is full, the writing control section 161 instructs writing on the next continuous data area.

On receiving a user's command to stop recording the VR-compliant stream 50, for example, the writing control section 161 finishes generating the VR-compliant stream 50 and starts to generate a VR-compliant stream 40a from the VR-compliant stream 50. More specifically, the writing control section 161 instructs the writing section 120 to delete the management data of the last VOB of the VR-compliant stream 50 and change the GOP associated with that VOBU into the second GOP of the previous VOBU. As a result, the formerly previous VOBU now includes two GOPs. By performing these processing steps, the writing control section 161 instructs the writing section 120 to generate management information, representing the attribute of each VOBU of the VR-compliant stream 40a, and record it on the optical disk 131 as a different data file from the VR-compliant stream 40a.

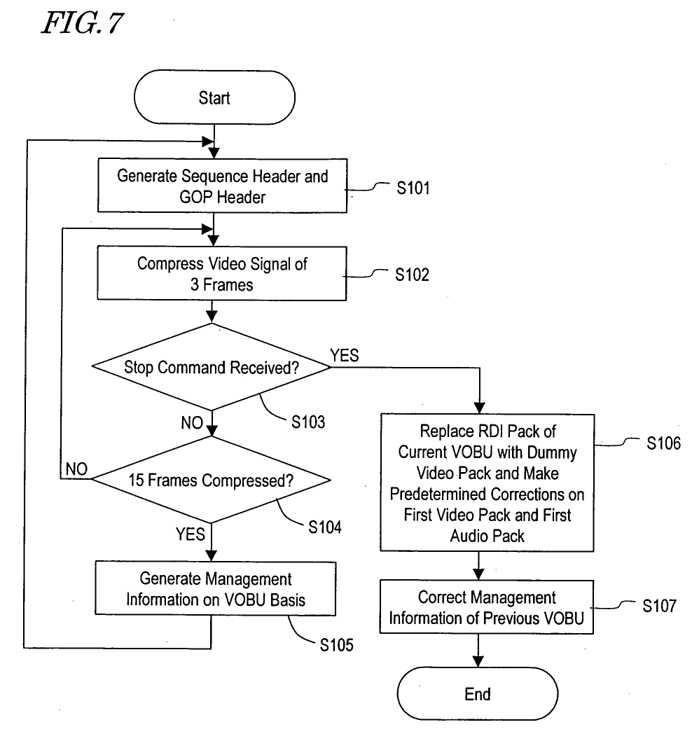

Hereinafter, the processing done by the writing control section 161 will be described in further detail with reference to FIG. 7. FIG. 7 is a flowchart showing how the writing control section 161 performs the GOP generating processing.

As to the data structure, GOP structure data (including a GOP header, the frame data of each frame and so on) are described in the video data in the video packs making up a VOBU as in the data structure shown in FIG. 1, for example. However, the RDI pack 11 and the pack header 12b, PES packet header 12c and so on of the video pack 12 shown in FIG. 1 have already been generated.

First, in Step S101, the writing control section 161 generates a sequence header and a GOP header. Next, in Step S102, the writing control section 161 instructs the encoder 170 to compress and encode a video signal having a predetermined number of frames. In this preferred embodiment, a video signal corresponding to three frames is compressed continuously. It should be noted that if the user instructs to stop the recording processing (to be described later) before those three frames have been processed, the compression processing is continuously carried out until the three frames have been processed even when the input of the video signal is interrupted. Since 30 video frames corresponds to a playback duration of 1 second, the writing control section 161 may be regarded as managing the compression processing on a 0.1 second basis. When I-, B- and P-frames are identified by their initial alphabets, one GOP may consist of such three-frame units including IBB, PBB, PBB, PBB and PBB. It should be noted that the “three-frame unit” is just an example. Alternatively, a one-frame unit (e.g., every unit may consist of an I-frame), a two-frame unit (e.g., every unit may consist of IP frames) or a unit consisting of five or more frames may also be used. Besides, compression does not always have to be done on the three-frame basis regularly but may also be carried out irregularly, e.g., on a four-frame basis first and then on a three-frame basis. For example, compression may be done on IPBB, PBB, PBB and PBB.

Next, in Step S103, the writing control section 161 determines whether or not it has received a user's stop command. The stop command may be given by pressing down a video recording button (not shown) provided for the data processor 60. If the answer is NO, the process advances to Step S104. On the other hand, if the answer is YES, then the process advances to Step S106.

In Step S104, the writing control section 161 determines whether or not 15 frames have been compressed yet. If the answer is YES, the process advances to Step S105. Otherwise, the process goes back to Step S102, thereby making the writing control section 161 instruct the video compressing section 101 to continue the compression processing until 15 frames have been compressed completely. In this preferred embodiment, when 15 frames have been compressed, those frames will be combined together into a single GOP, thereby forming a single VOBU.

In Step S105, the writing control section 161 generates management information on a VOBU-by-VOBU basis. The management information includes information that can specify a VOBU number showing the count of the given VOBU, the data size of that VOBU and the number of frames included in the VOBU. When the processing step S105 is done, the process returns to Step S101 again to start generating the next VOBU.

On the other hand, processing steps S106 and S107 are carried out in response to the user's stop command. First, in Step S106, the writing control section 161 instructs the writing section 120 to change the RDI pack of the VOBU, on which the recording processing has been carried out, into a dummy video pack. Then, the writing control section 161 makes predetermined corrections on the first video pack and first audio pack of the VOBU. These video and audio packs are corrected as follows.

First, the writing control section 161 deletes the system header from the first video pack of VOBU(n+1) and the P-STD buffer field from the PES extension field, respectively. While deleting those fields, the writing control section 161 generates a PES packet including a padding stream and adds it to the end of the video pack, thereby adjusting the data size of a single pack to 2 KB. If all padding streams have already been recorded, one of the recorded padding streams is extended.

Also, the writing control section 161 deletes the P-STD buffer field from the PES extension field of the first audio pack of VOBU(n+1). And the writing control section 161 generates either a stuffing field within a pack header or a PES packet including a padding stream and adds it to the end of the audio pack, thereby adjusting the data size of a single pack to 2 KB. If all padding streams have already been recorded, one of the recorded padding streams is extended.

As used herein, the “PES extension field” is a field in which information for decoding a program stream, e.g., information about the capacity of a decoding data buffer, is described. The PES extension field is provided for the first video pack and the first audio pack of each VOBU in a VR-compliant stream. The PES packet header for video and audio includes a packet length field and a flag field. The flag field includes a PES extension flag field, of which the value shows whether or not the PES extension field is present. For example, if the value of the PES extension flag field is one, a PES extension field is present. On the other hand, if the value is zero, no PES extension field is present.

Next, in Step S107, the management information of the VOBU that has just been recorded is corrected.

The following Table 1 shows exemplary management information to be corrected:

TABLE 1

| VOBU # | VOBU size (MB) | Number of Frames |
|---|---|---|
| 1 | 0.6 | 15 |
| 2 | 0.6 | 15 |
| . . . | . . . | . . . |
| n − 1 | 0.6 | 15 |
| n | 0.6 | 15 |
| (n + 1) | (0.36) | (9) |

In Table 1, the data sizes of VOBUs are shown when the data size of a single frame is simply supposed to be 0.02 megabytes for the sake of simplicity. Also, in Table 1, the management information of VOBU(n+1), on which the recording processing is being carried out, has not yet been generated actually and shown in parentheses.

Next, the following Table 2 shows corrected management information:

TABLE 2

| VOBU # | VOBU size (MB) | Number of Frames |
|---|---|---|
| 1 | 0.6 | 15 |
| 2 | 0.6 | 15 |
| . . . | . . . | . . . |
| n − 1 | 0.6 | 15 |
| n | 0.96 | 24 |

As can be seen from Tables 1 and 2, the size and number of frames of VOBU(n) have been corrected in Table 2 and have increased by the size and number of frames of VOBU that was generated as VOBU(n+1). That is to say, 24 frames included in VOBU(n) in Table 2 is the sum of 15 frames included in GOP(n) and 9 frames included in GOP(n+1). See FIG. 5(b), for example.

As a result of this processing, every VOBU but the last VOBU(n) includes 15 frames corresponding to a playback duration of 0.5 second. On the other hand, the last VOBU(n) includes 16 to less than 30 frames corresponding to a playback duration of 0.5 second to less than 1.0 second.

In the example described above, the 9 frames of video data, included in VOBU(n+1) being written, are introduced into the previous VOBU(n). Alternatively, those frames may be discarded. Speaking more generally, if the playback duration of the VOBU(n+1) being generated is less than the minimum playback duration of 0.4 second that falls within both the playback duration range of the terminal VOBU of a VR-compliant stream 40a and that of the terminal VOBU of a Video-compliant stream 40b, then the PS assembling section 104 may discard that VOBU(n+1). In that case, the processing of converting the VR-compliant stream 40a can be speeded up. According to this processing technique, however, not all of the frames that had been subjected to the compression processing until the recording was stopped can be written. More particularly, video that covered less than 0.4 second just before the recording stop command was received cannot be saved. Thus, this point should be borne in mind.

Meanwhile, it is also possible to continue writing the VOBU(n+1) being generated until its playback duration reaches 0.4 second, instead of discarding that VOBU. According to this processing technique, the video that covered less than 0.4 second just before the recording stop (finish) command was received can be saved. However, it takes an extra time to get the processing done in response to the command, thus decreasing the processing speed.

The writing control section 161 sends the modified management information to the writing section 120, thereby getting it stored on the optical disk 131 as a different data file (with the file name “VR_MANGR.IFO”, for example) from the data file (with the file name “VR_MOVIE.VRO”) of the VR-compliant stream 40a.

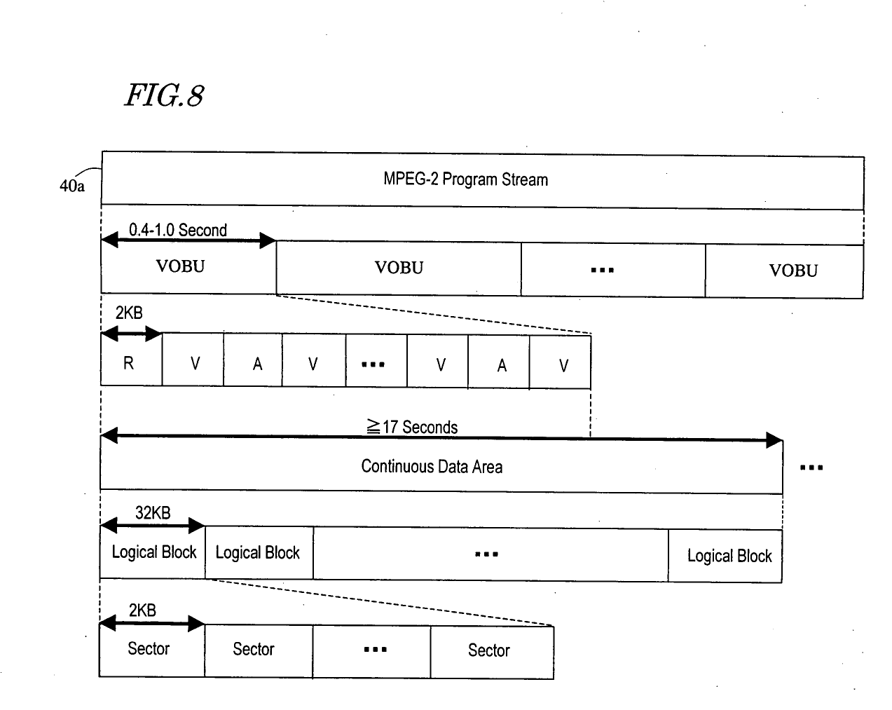

FIG. 8 shows a relationship between the VR-compliant stream 40a and the storage area of the optical disk 131. Each VOBU of the VR-compliant stream 40a that has been compressed and encoded so as to comply with the MPEG-2 standard is written on the continuous data area of the optical disk 131. The continuous data area consists of physically continuous logical blocks and can store data in at least 17 seconds when the data is played back at the maximum rate. The data processor 60 adds the error correction code to each logical block. The data size of each logical block is 32 kilobytes. Each logical block includes sixteen 2 KB sectors.

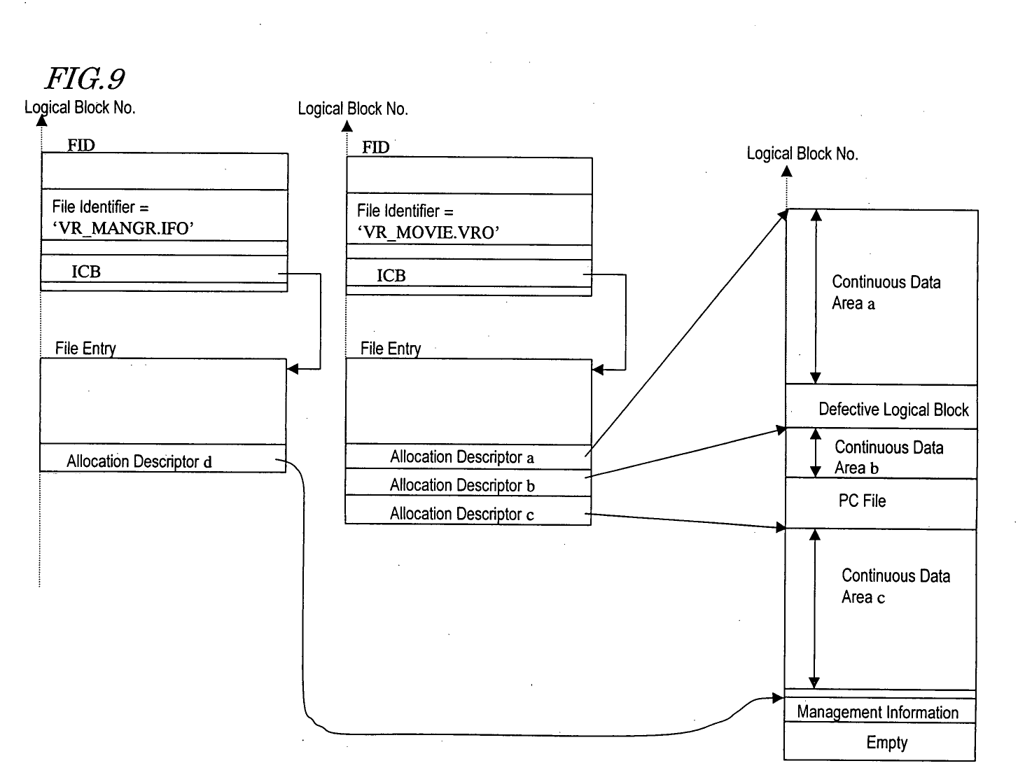

FIG. 9 shows how the VR-compliant stream 40a and management information recorded are managed by the file system of the optical disk 131. In this case, either a file system compliant with the universal disk format (UDF) standard or a file system compliant with ISO/IEC 13346 (Volume and File Structure of Write-Once and Rewritable Media Using Non-Sequential Recording for Information Interchange) may be used. In FIG. 9, the continuously written VR-compliant stream 40a is stored under the file name “VR_MOVIE.VRO”, while the management information is stored under the file name “VR_MANGR.IFO”. The file name and file entry location of each file are managed by a file identifier descriptor (FID). Furthermore, by using an allocation descriptor within the file entry, a file and the data area that makes up the file are associated with each other. A top sector number is defined as the location of the file entry making up the file for the allocation descriptor. The file entry of the VR-compliant stream includes allocation descriptors a through C for managing the continuous data areas (CDAs) a through C, respectively. One file is divided into these multiple areas a through c because there is a defective logical block, a non-writable PC file or something like that in the middle of the area a. On the other hand, the file entry of the management information file retains another allocation descriptor d to make reference to the management information storage area.

The logical block management section 163 manages the logical blocks by checking their availability on a logical block number basis, i.e., by being notified of the numbers of used logical blocks by the writing control section 161. More specifically, the logical block management section 163 manages each logical block by checking out, by the space bit descriptor area as defined by either UDF or ISO/IEC 13346 file architecture, whether each of the sector units that make up the logical block is used or unused. And at the last stage of the recording process, the logical block management section 163 writes the file identifier (FID) and file entry on the file management area on the disk.

It should be noted that the UDF standard corresponds to a subset of the ISO/IEC 13346 standard. By connecting a phase change optical disk drive to a PC by way of a 1394 interface and a serial bus protocol 2 (SBP-2), the PC can also treat a file that was written in a UDF compliant format as a single file.

More preferably, the management information file is recorded in an innermost area of optical disk physically collectively.

Next, components of the data processor 60 to perform the playback function will be described. The data processor 60 includes a reading section 121, an audio output section 112, a converting section 141, an output interface section 140, a reading control section 162, a conversion control section 164 and an MPEG-2 PS decoder 171.

Among various playback functions, the function of reading and decoding the VR-compliant stream 40a will be described. The MPEG2-PS decoder 171 (which will be simply referred to herein as a “decoder 171”) includes a program stream disassembling section 114, a video decompressing section 111 and an audio decompressing section 113. The program stream disassembling section 114 splits a program stream, which has been read by the pickup 130 and the reading section 121, into a video signal and an audio signal. The video decompressing section 111 and the audio decompressing section 113 decode the video signal and the audio signal, respectively, thereby getting the resultant video data and audio data displayed on the video display section 110 and output through the audio output section 112, respectively.

In playing back the VR-compliant stream 40a stored, the data processor 60 reads data from the optical disk 131 and decodes (reproduces) the read data in parallel with each other. In this case, the data reading rate is controlled so as to be higher than the maximum data decoding rate such that the data to reproduce is never exhausted. Accordingly, if the VR-compliant stream 40a continues being decoded, extra data to reproduce can be obtained by the difference between the maximum data decoding rate and the data reading rate per unit time. While the pickup 130 cannot read data (e.g., during a seek operation), the data processor 60 decodes the extra data, thereby playing back the VR-compliant stream 40a seamlessly.

Suppose the reading section 121 has a data reading rate of 11.08 Mbps, the PS disassembling section 114 has a maximum data decoding rate of 10.08 Mbps and the pickup has a longest move time of 1.5 seconds, for example. In that case, to play back the VR-compliant stream 40a seamlessly, extra data of 15.12 megabits is needed while the pickup 130 is moving. And to secure this amount of data, reading should be done continuously for 15.12 seconds. That is to say, that extra data should be read continuously for a period of time calculated by dividing 15.12 megabits by the difference between the data reading rate of 11.08 Mbps and the maximum data recording/decoding rate of 10.08 Mbps. Accordingly, while the data is being read continuously for 15.12 seconds, data of at most 167.53 megabits (i.e., data read in 16.62 seconds) will be read out. Thus, by securing a continuous data area corresponding to at least 16.62 seconds (approximately 17 seconds), continuous data playback can be guaranteed. A number of defective logical blocks may be included in the continuous data area. In that case, however, the time it will take to read those defective logical blocks during the playback should be taken into account, and therefore, the continuous data area needs to correspond to slightly longer than 16.62 seconds in playback time.

Next, the function of reading the VR-compliant stream 40a and converting it into the Video-compliant stream 40b will be described among other playback functions. The conversion control section 164 instructs the pickup 130 and reading section 121 to read the VR-compliant stream 40a. When started by the conversion control section 164, the converting section 141 replaces the RDI pack of the VR-compliant stream 40a with a navigation pack compliant with the Video standard. Also, the conversion control section 164 replaces a particular field (e.g., the P-STD buffer size field of a PES extension field), included in the first video pack and first audio pack of each VOBU, with dummy data. As used herein, the “dummy data” refers to either the stuffing data in a pack header or a PES packet including a padding stream. Furthermore, the conversion control section 164 performs other types of processing including rewriting SCR and shifting PTS/DTS.

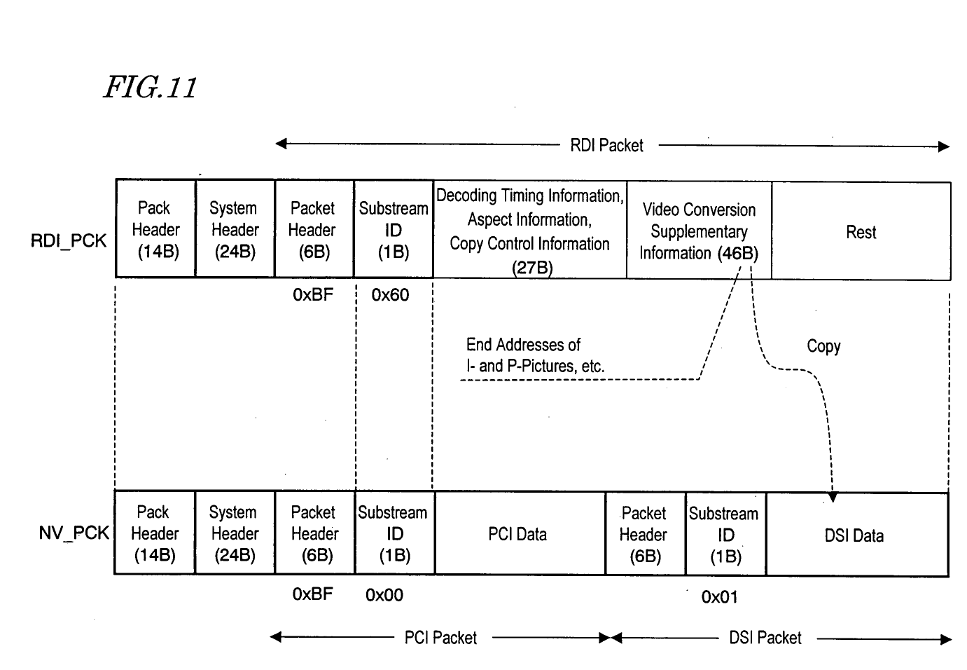

FIG. 11 shows a correlation between the RDI pack and the navigation pack. As the stream IDs of the RDI pack and navigation pack, the same stream ID 0×BF, which is defined as Private Stream 2 by the MPEG-2 System standard, is used. And to identify these two types, a substream ID 0×60 is used for an RDI packet and substream IDs 0×00 and 0×01 are used for a PCI packet and a DSI packet, respectively.

The writing control section 161 generates a field, which will be needed in making a navigation pack, in advance while generating the VR-compliant stream, and stores it as video conversion supplementary information in the manufacturer's information field in the RDI pack. The video conversion supplementary information is a value that cannot be obtained unless a video stream is analyzed, e.g., the end addresses of I- and P-pictures. Then, the conversion control section 164 may generate a navigation pack based on the video conversion supplementary information, thereby speeding up the processing. It is also necessary to make a skip destination address by reference to the data size of each VOBU, which is stored as a piece of management information, and to store the address in the navigation pack. Although other values need to be defined for the navigation pack, the description thereof will be omitted herein.

Unless the video conversion supplementary information is stored, it is necessary to extract the end addresses of I- and P-pictures and store them in the navigation pack by recording the stream once and then analyzing the stream. According to this processing technique, however, it takes a certain amount of additional time to get the conversion processing done.

Also, the management information may include information showing whether or not the video conversion supplementary information is stored in the RDI pack.

Furthermore, the converting section 141 may use the video data 12a included in a video pack of the VR-compliant stream 40a as it is as the video data for a video pack of the Video-compliant stream 40b. According to this processing technique, there is no need to perform the compression and encoding process again. The data processor 60 modifies a portion of the data of the last VOBU and its management information and records a VR-compliant stream 40a, which does not have to be recompressed or re-encoded while being converted into a Video-compliant stream, on the optical disk 131. Thus, no matter whether or not the given VOBU is the last one, the converting section 141 can always perform the same conversion processing on each and every VOBU. That is why the data processor 60 does not have to determine whether or not this is the last VOBU when the VR-compliant stream is converted into a Video-compliant stream and does not need any configuration for recompressing and re-encoding each frame when the last VOBU has a playback duration of less than 0.4 second. Consequently, the processing load can be lightened and the processing time can be shortened.

In the foregoing description, the playback duration of every VOBU but the last one is supposed to be adjusted to 0.5 second. However, this value is just an example. Thus, the same statement applies if every VOBU but the last one is designed so as to have a playback duration of 0.6 second or less and if the last VOBU is designed so as to have a playback duration of 0.4 second through 1.0 second. In that case, in Step S104 shown in FIG. 7, it is determined whether or not 18 frames have been compressed and encoded.

If the input video signal is compliant with the PAL 657/50 TV System, then it is preferably determined in Step S104, for a single GOP in every VOBU but the last one, whether or not 12 frames have been compressed yet. Then, calculations can be simplified.

The output interface section 140 sequentially outputs the Video-compliant stream 40b resulting from this conversion processing. Supposing the output interface section 140 is compliant with either the IEEE 1394 standard (that uses SBP-2 Protocol) or the USB standard (that uses Mass-Storage Class) and is connected to a DVD-R drive, the Video-compliant stream 40b, obtained by the conversion, is output through the output interface section 140 and then recorded by the DVD-R drive on a DVD-R disk.

In the preferred embodiment described above, a VR-compliant stream and a Video-compliant stream, which are both program streams, are used. Alternatively, a system stream compliant with the MPEG-1 standard may also be used. Furthermore, the storage medium is supposed herein to be a phase change optical disk. Alternatively, any other optical disk such as a DVD-RAM, a DVD-R, a DVD−RW, a DVD+RW, an MO, a CD-R or a CD-RW or a different type of disk storage medium such as a hard disk may also be used. Optionally, the storage medium may even be a semiconductor memory such as a buffer memory (not shown) of the apparatus. In this connection, although the read/write head is supposed herein to be a pickup for an optical disk, the read/write head will be a pickup and a magnetic head if the storage medium is an MO and will be a magnetic head alone if the storage medium is a hard disk.

In the preferred embodiments described above, a video signal and other signals are once stored as a VR-compliant stream, which is then converted into a Video-compliant stream. Conversely, the video signal and other signals may be once stored as a Video-compliant stream and then converted into a VR-compliant stream.

The data processor 60 can perform the processing of generating, writing and reading a data stream 40a according to a computer program. For example, the processing of generating an encoded stream of a given content so that the stream can be easily subjected to format conversion may be carried out by executing a computer program that is described based on the flowchart shown in FIG. 7. The computer program may be stored in any of various types of storage media. Examples of preferred storage media include optical storage media such as optical disks, semiconductor storage media such as an SD memory card and an EEPROM, and magnetic recording media such as a flexible disk. Instead of using such a storage medium, the computer program may also be downloaded via a telecommunications line (e.g., through the Internet, for example) and installed in the optical disc drive.

In the preferred embodiment described above, the VR-compliant stream is supposed to be stored as VR_MOVIE.VRO file and the management information is supposed to be stored as VR_MANGR.IFO file. Alternatively, each moving picture stream may consist of two or more files and the management information for each of those moving picture stream files may be stored as an independent management information file. In that case, information showing the correlation between each moving picture stream file and its associated management information file should also be recorded by giving their file names the same number, for example. Furthermore, all of those management information files are preferably stored collectively in a particular area on the optical disk.

In the preferred embodiment described above, a stream is supposed to be recorded in a format compliant with the VR standard. However, the RDI pack stored at the top of a VOBU may be replaced with a unique type of pack that has had its substream ID value changed into a particular value (e.g., 0×FF). Then, the stream can be easily converted into not only a VR-compliant stream but also a Video-compliant stream as well. Furthermore, if both a stream including such a unique pack and a VR-compliant stream may be recorded on the same optical disk, then the management information should include information identifying those streams.

Preferred embodiments of the present invention have been described as being applied to MPEG-2 program streams. However, the processing of the present invention is similarly applicable to any other type of streams (e.g., MPEG-2 transport streams).

In the preferred embodiment described above, one VOBU is supposed to consist of a single GOP that is made up of 15 frames as shown in FIG. 7. However, at a so-called “scene change” timing at which the scene of the object or the program changes into a quite different one, a smaller number of frames may be included in one GOP. For example, by allocating an I-frame to a frame at which the scene change has been detected, the GOP may be cut off at the previous frame even if the number of frames is still less than 15. In that case, the previous GOP and the new GOP may include 15 frames combined.

It has not been mentioned particularly how to process audio frames. However, the audio frames to be played back synchronously with the video frames of the last VOBU are preferably included in the same last VOBU, too. The same statement applies to the VR-compliant stream including connection points as shown in FIGS. 12 and 13. That is to say, the audio frames to be played back synchronously with the video frames of the previous VOBU, located just before the connection point, are preferably included in that previous VOBU, too.

In the preferred embodiment shown in FIG. 5, if the playback duration of VOBU(n+1) is 0.5 second through 1 second, then VOBU(n+1) does not have to be combined with its previous VOBU(n).

### INDUSTRIAL APPLICABILITY

According to the present invention, provided is a method and apparatus for converting all video frames of a data stream in a format, in which video information and audio information are encoded, into counterparts of a data stream in a different format without recompressing and re-encoding the former stream. Since there is no need to recompress and re-encode the video when the video or audio frames stored are converted into counterparts in a different format, the processing can be speeded up significantly and the processing load can be lightened. Thus, it is very easy to implement this method even in an apparatus with low processing performance.

1. A method for selectively recording a first data stream in a first format, not a second data stream in a second format, on a storage medium,
wherein each said data stream is an arrangement of a plurality of data units, each including compressed and encoded video data, and
wherein in the first format, a first time range is set to define a permissible variation in the video playback duration of the respective data units, and
wherein in the second format, a second time range is set to define a permissible variation in the video playback duration of the respective data units,
the method comprising the steps of:
receiving a content representing the video;
generating the compressed and encoded video data of the content;
making the data units out of the video data such that the playback duration of each said data unit falls within both of the first and second time ranges; and
recording the first data stream, including the data units, on the storage medium.

2. The recording method of claim 1, wherein the first time range includes a time range for a first terminal data unit, which is located at the end of the first data stream, and a time range for the data units other than the first terminal data unit, and
wherein the second time range includes a time range for a second terminal data unit, which is located at the end of the second data stream, and a time range for the data units other than the second terminal data unit, and
wherein the step of making the data units includes making the terminal data units such that the playback duration of each said terminal data unit falls within the respective time ranges of both the first and second terminal data units.

3. The recording method of claim 2, wherein if the playback duration of a data unit being made when the first data stream finishes being recorded is less than the minimum value of the playback duration of the terminal data unit that falls within both of the two time ranges,
the step of making the data units includes combining the data unit being made with its previous data unit, thereby making the terminal data unit, of which the playback duration is the minimum value of the two time ranges.

4. The recording method of claim 1, further comprising the step of generating management information about the amount of data and the number of pictures included in each said data unit,
wherein the step of recording includes recording the management information on the storage medium as a different data stream from the first data stream.

5. The recording method of claim 2, wherein the time range for the first terminal data unit is 0 second through 1 second, and the time range for the second terminal data unit is 0.4 second through 1.2 seconds.

6. The recording method of claim 5, wherein the time range for the data units other than the first terminal data unit and the time range for the data units other than the second terminal data unit are both 0.4 second through 1.0 second.

7. The recording method of claim 1, wherein the first time range is 0 second through 1 second, and the second time range is 0.4 second through 1.2 seconds.

8. The recording method of claim 2, wherein if the playback duration of a data unit being made when the first data stream finishes being recorded is less than the minimum value of the playback duration that falls within both of the two time ranges, then the step of making the data units includes discarding the data unit being made.

9. The recording method of claim 2, wherein the step of making the data units includes
receiving an instruction to stop recording the first data stream and
if the playback duration of a data unit being made when the instruction is received is less than the minimum value of the playback duration that falls within both of the two time ranges, continuing recording until the playback duration reaches the minimum value.

10. An apparatus for selectively recording a first data stream in a first format, not a second data stream in a second format, on a storage medium,
wherein each said data stream is an arrangement of a plurality of data units, each including compressed and encoded video data, and
wherein in the first format, a first time range is set to define a permissible variation in the video playback duration of the respective data units, and
wherein in the second format, a second time range is set to define a permissible variation in the video playback duration of the respective data units,
the apparatus comprising:
an input section for receiving a content representing the video;
a compressing section for generating the compressed and encoded video data of the content;
a stream assembling section for making the data units out of the video data such that the playback duration of each said data unit falls within both of the first and second time ranges; and
a writing section for recording the first data stream, including the data units, on the storage medium.

11. The apparatus of claim 10, wherein the first time range includes a time range for a first terminal data unit, which is located at the end of the first data stream, and a time range for the data units other than the first terminal data unit, and
wherein the second time range includes a time range for a second terminal data unit, which is located at the end of the second data stream, and a time range for the data units other than the second terminal data unit, and
wherein the stream assembling section makes the terminal data units such that the playback duration of each said terminal data unit falls within the respective time ranges of both the first and second terminal data units.

12. The apparatus of claim 11, wherein if the playback duration of a data unit being made when the first data stream finishes being recorded is less than the minimum value of the playback duration of the terminal data unit that falls within both of the two time ranges,
the stream assembling section combines the data unit being made with its previous data unit, thereby making the terminal data unit, of which the playback duration is the minimum value of the two time ranges.

13. The apparatus of claim 10, further comprising a control section for generating management information about the amount of data and the number of pictures included in each said data unit,
wherein the writing section records the management information on the storage medium as a different data stream from the first data stream.

14. The apparatus of claim 11, wherein the time range for the first terminal data unit is 0 second through 1 second, and the time range for the second terminal data unit is 0.4 second through 1.2 seconds.

15. The apparatus of claim 14, wherein the time range for the data units other than the first terminal data unit and the time range for the data units other than the second terminal data unit are both 0.4 second through 1.0 second.

16. The apparatus of claim 10, wherein the first time range is 0 second through 1 second, and the second time range is 0.4 second through 1.2 seconds.

17. The apparatus of claim 11, wherein if the playback duration of a data unit being made when the first data stream finishes being recorded is less than the minimum value of the playback duration that falls within both of the two time ranges, then the stream assembling section discards the data unit being made.

18. The apparatus of claim 11, wherein the stream assembling section receives an instruction to stop recording the first data stream, and if the playback duration of a data unit being made when the instruction is received is less than the minimum value of the playback duration that falls within both of the two time ranges, the stream assembling section continues recording until the playback duration reaches the minimum value.

19. A computer program product of a recording program, the program being executable by a computer to be used to selectively record a first data stream in a first format, not a second data stream in a second format, on a storage medium,
wherein each said data stream is an arrangement of a plurality of data units, each including compressed and encoded video data, and
wherein in the first format, a first time range is set to define a permissible variation in the video playback duration of the respective data units, and
wherein in the second format, a second time range is set to define a permissible variation in the video playback duration of the respective data units,
the program which when executed by the computer causes the computer to perform a processing, the processing comprising the steps of:
receiving a content representing the video;
generating the compressed and encoded video data of the content;
making the data units out of the video data such that the playback duration of each said data unit falls within both of the first and second time ranges; and
recording the first data stream, including the data units, on the storage medium.
